(19) United States
(12) Patent Application Publication
(10) Pub. No.: US 2010/0284717 A1
(43) Pub. Date: Nov. 11, 2010

(54) SHEET HUMIDIFICATION DEVICE AND IMAGE FORMING SYSTEM

(75) Inventor: Toshio Shida, Tokyo (JP)

Correspondence Address: CANTOR COLBURN, LLP, 20 Church Street, 22nd Floor, Hartford, CT, 06103, US

(73) Assignee: KONICA MINOLTA BUSINESS TECHNOLOGIES, INC., Tokyo (JP)

(21) Appl. No.: 12/810,747

(22) PCT Filed: Aug. 21, 2009
(86) PCT No.: PCT/JP2009/064626

§ 371 Date: Jun. 25, 2010

(30) Foreign Application Priority Data
Sep. 19, 2008 (JP) 2008-240597

(51) Int. Cl. G03G 15/20

(52) U.S. Cl. 399/341

(57) ABSTRACT

A sheet humidification device for performing the humidifying process to a sheet fed from an image forming apparatus for heating the sheet carrying a toner image and fixing the image, including: a humidifying rollers for coating water on the sheet, and a water supply rollers arranged opposite to the humidifying rollers for supplying water to the humidifying rollers, wherein the surface roughness of the humidifying rollers is higher than the surface roughness of the water supply rollers.

### CROSS REFERENCE TO RELATED APPLICATIONS

This is a U.S. national stage of application No. PCT/JP2009/064626, filed on 21 Aug. 2009. Priority under 35 U.S.C. §119(a) and 35 U.S.C. §365(b) is claimed from Japanese Application No. 2008-240597, filed 19 Sep. 2008, the disclosure of which is also incorporated herein by reference.

### FIELD OF THE INVENTION

The present invention relates to a sheet humidification device for humidifying sheets and an image forming system connected with the sheet humidification device and an image forming apparatus.

### PRIOR ART

An electrophotographic image forming apparatus transfers a toner image formed on a photoconductor onto a sheet, heats and conveys the sheet carrying the transferred toner image, thereby fixing the toner image on the sheet, and then after the fixing process sends out the sheet from the apparatus.

On the sheet with moisture taken out by the aforementioned fixing process accompanied by heating, deformation such as surface waviness or curls often develop and the developed deformation of the sheet causes a fault in the conveyance of the sheet after the fixing process and in the post-process such as bookbinding.

To solve such a problem, an art for humidifying a sheet after the fixing process and correcting the deformation of the sheet is proposed.

For example, in Patent Document 1, a sheet humidification device structured so as to form a nip portion composed of a rubber roller for conveying sheets and a hydrophilic chrome plated humidifying roller which are arranged opposite to each other, rotate the humidifying roller in the direction opposite from the direction of the rubber roller by supplying water by a water supply roller for forming a water film on the humidifying roller, thereby humidify the sheet passing through the nip portion is described.

Further, in Patent Document 2, a sheet humidification device for supplying water to at least one of a pair of humidifying rollers having a porous layer and humidifying a sheet by conveying it to the pair of humidifying rollers is described.

Further, in Patent Document 3, a sheet humidification device for humidifying both sides of a sheet by conveying it by humidifying rollers having fibriform elastomer surfaces rotating opposite to each other is described.

However, in the sheet humidification device cited as an example, that is, the sheet humidification device for performing the humidifying process for a sheet by conveying it by the rollers rotating opposite to each other, if the rollers rotate continuously when there are no sheets in the nip portion, a pool occurs in the nip portion.

The pool is adhered in a concentrated manner to the leading edge of a sheet newly fed for the humidifying process, so that the leading edge of the sheet is humidified excessively, thus a plurality of undulations referred to as surface waviness develop at the leading edge of the sheet.

### Document of Prior Art

### Patent Document

Patent Document 1: U.S. Pat. No. 5,832,359

Patent Document 2: Japanese Patent Application Publication No. 2006-8282

Patent Document 3: U.S. Pat. No. 5,895,154

### SUMMARY OF THE INVENTION

### Problems to be Solved by the Invention

The present invention was developed with the foregoing in view and is intended to realize a sheet humidification device for performing a humidifying process for a sheet by conveying it by rollers rotating opposite to each other, wherein formation of a pool occurring in a nip portion is suppressed, thus an occurrence of surface waviness at the end portion of the sheet is prevented.

### Means for Solving the Problems

The aforementioned problem can be solved by realization of the following inventions.

(1) A sheet humidification device for performing a humidifying process to a sheet fed from an image forming apparatus fixing a toner image by heating the sheet carrying the toner image, including: a humidifying roller for coating water on the sheet, and a water supply roller arranged opposite to the humidifying roller for supplying water to the humidifying roller, wherein a surface roughness of the humidifying roller is higher than the surface roughness of the water supply roller.
(2) The sheet humidification device described in Item 1 in which the humidifying roller and the water supply roller are composed of hydrophilic NBR rubber.
(3) The sheet humidification device described in Item 1 including two sets of humidification mechanisms such having the humidifying roller, the water supply roller, and water storage pan for storing humidifying water and permitting the water supply roller to be partially immersed, wherein the humidifying rollers of the two sets of humidification mechanisms are arranged opposite to each other and the two sets of humidification mechanisms are arranged symmetrically on right and left, and water is coated on both sides of the sheet by conveying the sheet upward from below by the opposing humidifying rollers.
(4) The sheet humidification device described in Item 1 further including a control roller for controlling the water retention quantity of the water supply roller by pressurizing the water supply roller.
(5) An image forming system connected with an image forming apparatus and the sheet humidification device described in Item 1.

### EFFECTS OF THE INVENTION

According to the present invention, the formation of a pool occurring in the nip portion in the sheet humidification device for performing the humidifying process for a sheet by conveying it by the rollers rotating opposite to each other is suppressed, so that the surface waviness developing at the leading edge of the sheet due to excessive humidification is eliminated.

As a result, the conveyance of sheets after the humidifying process and the post-process such as bookbinding are stabilized.

### BRIEF DESCRIPTION OF THE DRAWINGS

FIG. 1 is a conceptual diagram of the image forming system connected with the humidification device.

FIG. 2 is a conceptual diagram of the humidification device.

FIG. 3 is a drawing for explaining the humidifying unit.

FIG. 4 is a drawing showing the position of the pool formed in the humidifying unit.

FIG. 5 is a conceptual diagram of the surface waviness developing at the leading edge of a sheet.

FIG. 6 is a drawing for explaining the surface waviness quantity.

FIG. 7a is a graph showing the relationship between the surface roughness of the humidifying rollers and water supply rollers and the size of the developed surface waviness.

FIG. 7b is a graph showing the relationship between the surface roughness of the humidifying rollers and water supply rollers and the size of the developed surface waviness.

FIG. 8 is a drawing showing the specification of each roller used in the experimentation.

### DETAILED DESCRIPTION OF THE INVENTION

Hereinafter, the embodiment of the present invention will be explained with reference to the accompanying drawings. Further, the present invention is not limited to the embodiment explained.

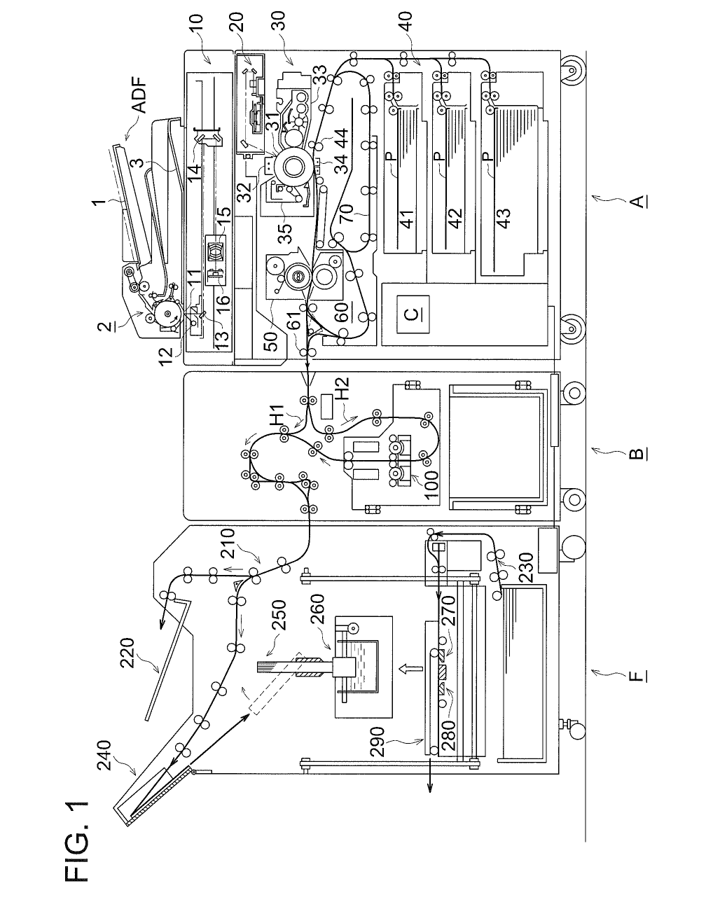

FIG. 1 is a conceptual diagram of the image forming system connected with a humidification device B. The image forming system drawn is composed of an image forming apparatus A, the humidification device B, and a bookbinding device F.

The image forming apparatus A is an electrophotographic image forming apparatus having an automatic document feeder ADF on the upper part.

Documents loaded on a document loading table 1 of the automatic document feeder ADF are fed one by one to a document conveying portion 2 and are discharged to a document discharge portion 3.

The image surface of the conveyed document is read by an optical system including a light source 12, a first mirror 13, a second mirror 14, a lens 15, and an image pickup device 16 at a reading position 11 of a reading unit 10 of the image forming apparatus A and the read image information is stored in a memory of a controller C.

A writing unit 20 includes a laser beam generation unit and a polygonal mirror, and on the basis of the image information stored in the memory of the controller C, scans and exposes the surface of a charged photoconductor 31 of an image forming unit 30, and forms a latent image on the surface of the photoconductor.

The image forming unit 30 includes the photoconductor 31 and a charging electrode 32, a developing unit 33, a transfer separation electrode 34, and a cleaning unit 35 which are arranged around the photoconductor 31, develops the latent image formed on the surface of the photoconductor 31 by the developing unit 33, and forms a toner image on the surface of the photoconductor 31.

The formed toner image is fed from any one of paper feed trays 41, 42, and 43 of a paper feed unit 40 by an action of the transfer separation electrode 34 and is transferred onto a sheet P fed toward the timed photoconductor 31 by paper feed rollers 44.

The sheet P carrying the toner image is heated under pressure and heated by a fixing unit 50 and the toner image is fixed onto the sheet P. The sheet P subjected to the fixing process is fed to the sheet humidification device B by the sheet discharge rollers 61 of a sheet discharge-reversing unit 60.

When forming the image on both sides of the sheet P, the sheet P subjected to the fixing process is fed from the sheet discharge-reversing unit 60 to a sheet refeed unit 70. The sheet refeed unit 70, to form an image on the back of the fed sheet P, once more feeds the sheet P to the sheet feed unit 40.

The humidification device B is a device connected to the downstream side of the image forming apparatus A for humidifying the sheet P fed from the image forming apparatus A by coating water on both sides thereof, thereby removing the curl of the sheet formed by the fixing process of the image forming apparatus A.

When performing no humidifying process for the sheet P, the humidification device B leads the sheet P to a sheet conveying path H1 and feeds it to the bookbinding device F and when performing the humidifying process, leads the sheet P so as to move forward on a sheet conveying path H2 with a humidifying unit 100 equipped. Further, the humidification device B will be explained later in detail.

The bookbinding device F is a typical post processing device for stacking the sheets P flattened by the humidification device B to form a sheet bundle and adheres a cover sheet to the spine of the formed sheet bundle to bind a book.

The bookbinding device F is composed of a sheet conveying means 210, a sheet discharge means 220, a cover sheet feed means 230, a sheet bundle storing means 240, a sheet bundle holding means 250, a pasting means 260, a cover sheet adhering means 270, a cover sheet folding means 280, and a booklet discharge means 290.

The respective means, as shown in the drawing, are all set in the longitudinal arrangement in the vertical direction in the apparatus.

When a processing mode of performing no bookbinding process for the sheets P is set, the sheets P fed from the humidification device B are fed to the sheet discharge means 220 by the sheet conveying means 210 and when the processing mode of performing the bookbinding process is set, the sheets P are fed to the sheet bundle storing means 240.

The sheets P fed to the sheet bundle storing means 240 and sequentially stacked are formed as a sheet bundle composed of a predetermined number of sheets.

The sheet bundle formed on the sheet bundle storing means 240 is fed to the sheet bundle holding means 250 and the sheet bundle holding means 250 rotates with the sheet bundle held up to the position where the sheet bundle is almost vertical.

The bottom of the sheet bundle held vertically by the sheet bundle holding means 250 is pasted by the pasting means 260, thus the sheet bundle is bound at the bottom.

To the bound sheet bundle, a cover sheet is adhered by the cover sheet adhering means 270, and then the adhered cover sheet is folded along the sheet bundle by the cover sheet folding means 280, thus a booklet is completed. The formed booklet is discharged to a booklet storing tray outside the bookbinding device F by the booklet discharge means 290.

Further, the bookbinding device F as mentioned above is a disclosed device as described in Japanese Patent Application Publication No. 2004-209869.

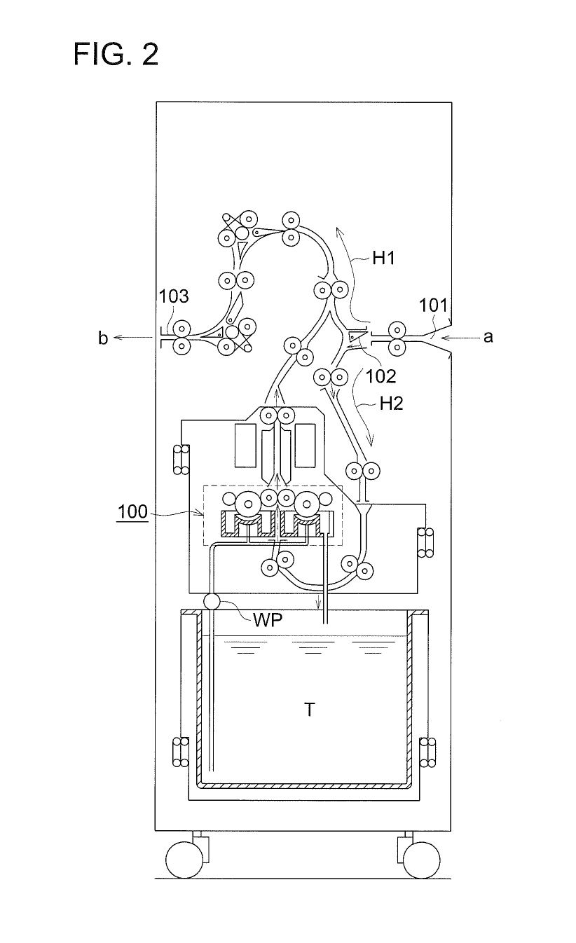

FIG. 2 is a conceptual diagram of the humidification device B.

The sheets P fed from the image forming apparatus A enter the humidification device B in the direction of an arrow a and are fed to the bookbinding device F arranged in the direction of an arrow b.

The sheet conveying path on which the sheets P move forward is composed of the first conveying path H1 of leading the sheets P upward from a sheet entering port 101 by a conveying path switching guide 102 and then conveying them up to a discharge port 103 and the second conveying path H2 of leading the sheets P downward by the conveying path switching guide 102 and then conveying the sheets P after the humidifying process up to the discharge port 103.

Namely, the sheet conveying path is structured so as to permit the first conveying path H1 to perform no humidifying process for the sheets P fed from the image forming apparatus A and the second conveying path H2 to feed the sheets P to the humidifying unit 100, perform the humidifying process, and feed them to the device connected to the downstream side.

Under the humidifying unit 100, a tank T for storing water used for humidification is arranged and the water in the tank T is sent to the humidifying unit 100 by a pump WP. Further, water overflowing from the humidifying unit 100 is returned to the tank T and is used again.

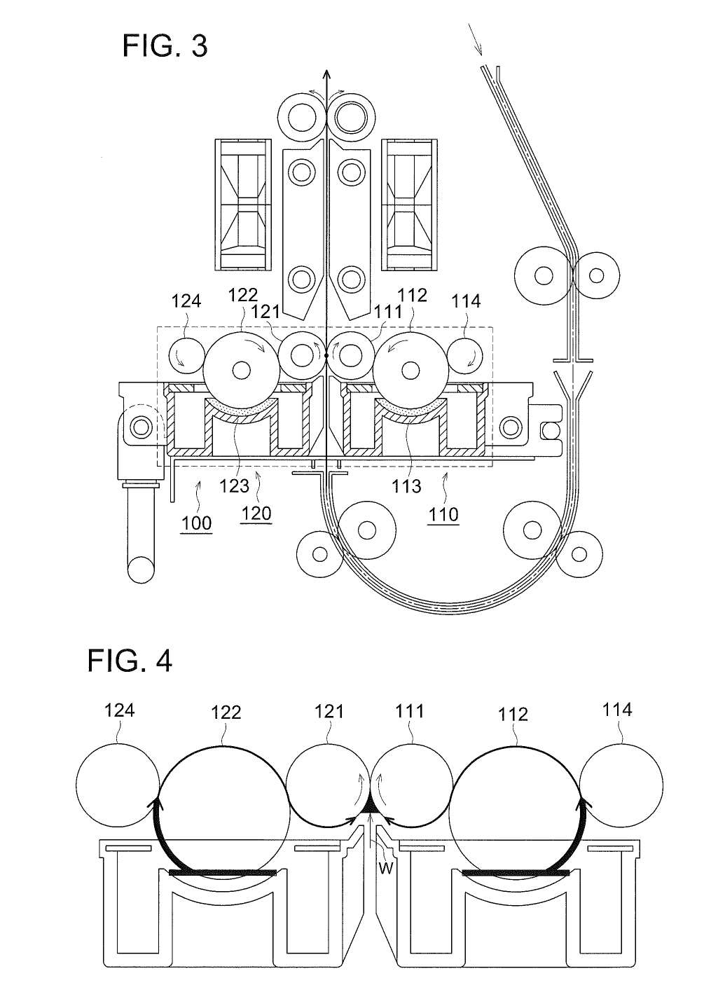

FIG. 3 is a drawing for explaining the humidifying unit 100.

The humidifying unit 100 is composed of two sets of humidification mechanisms for coating water on one side of the sheet P.

The humidifying unit 100 in the dotted line area shown in the drawing coats water on both sides of the sheet P by conveying the sheet P upward from below by humidifying rollers 111 and 121 of humidification mechanisms 110 and 120 which are arranged opposite to each other.

The humidification mechanism 110 includes a humidifying roller 111, a water supply roller 112 for supplying water to the humidifying roller 111, a water storing pan 113 for storing water to be coated and permitting the water supply roller 112 to be immersed partially, and a control roller 114 for pressurizing the surface of the water supply roller 112.

Similarly, the humidification mechanism 120 includes a humidifying roller 121, a water supply roller 122, a water storing pan 123, and a control roller 124.

The humidifying unit 100 includes the two sets of the humidification mechanisms as mentioned above, wherein the humidifying rollers of the two sets of the humidification mechanisms are installed opposite to each other, thus the humidification mechanisms are arranged symmetrically on the right and left.

The water supply rollers 112 and 122 that are arranged at the positions opposite to the humidifying rollers 111 and 121 and are partially immersed in the water stored in the water storing pans 113 and 123 are hydrophilic solid rubber rollers and transfer water adhered to the surfaces thereof to the humidifying rollers 111 and 121.

With the water supply rollers 112 and 122, the control rollers 114 and 124 are in contact so as to pressurize the water supply rollers 112 and 122, and the pressure is changed, thus the water retention quantity of the water supply rollers is changed, and the water supply quantity to the humidifying rollers 111 and 121 by the water supply rollers 112 and 122 is changed.

Namely, the pressure of the control rollers 114 and 124 is changed, thus the humidifying quantity for the sheets P can be changed.

The control rollers 114 and 124 are metallic rollers and are pressurized against the water supply rollers by a pressing means (not drawn). The pressing means is a means for pressurizing the shafts or bearings at both ends of the control rollers 114 and 124 by a spring and the magnitude of the pressure is determined by the screw for adjusting the position of the end of the spring.

When there are no sheets P to be subjected to the humidifying process in the humidifying unit 100, the two humidifying rollers 111 and 121 rotate opposite to each other in the state that water to be coated is included.

In such a state, in the position where the humidifying rollers 111 and 121 are opposite to each other, that is, in the nip portion, a pool occurs. The pool occurring in this way is adhered to the leading edge of the sheet P subjected next to the humidifying process and a deformed area referred to as surface waviness is formed at the leading edge.

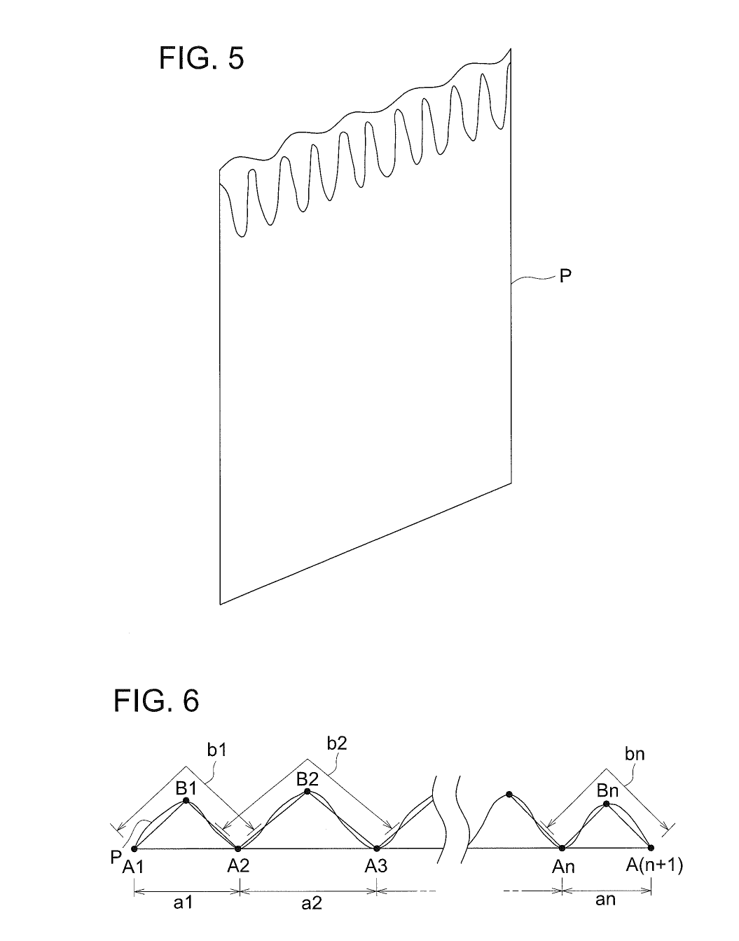

FIG. 4 is a drawing showing the position of the pool W formed in the humidifying unit 100 and FIG. 5 is a conceptual diagram of the surface waviness developing at the leading edge of the sheet P.

This surface waviness formed at the leading edge may cause a fault to the conveyance of sheets and the quality of a booklet bound may be lowered.

The present invention suppresses the aforementioned occurrence of the pool W, thereby preventing the surface waviness from developing at the leading edge of the sheet P.

When there are no sheets P to be humidified between the humidifying rollers, the water transferred from the water supply rollers 112 and 122 to the humidifying rollers 111 and 121 is not coated on the sheets P from the humidifying rollers 111 and 121, thus the water supplied is more than the water retention quantity of the humidifying rollers 111 and 121 and stays at the position shown in FIG. 4 as a pool W.

To suppress the occurrence of such a pool, it is effective to increase the water retention quantity of the humidifying rollers 111 and 121 and decrease the water supply quantity to be supplied to the humidifying rollers 111 and 121 from the water supply rollers 112 and 122.

Namely, due to an increase in the water retention quantity of the humidifying rollers 111 and 121, the water fed to the humidifying rollers 111 and 121 is held on the surfaces of the two rollers and passes through the opposite position.

Further, the supply quantity of the water supply rollers 112 and 122 is reduced as long as no fault is caused to the humidifying process, thus the water supply beyond the water retention quantity of the humidifying rollers 111 and 121 can be prevented.

The present invention, from the relationship between the surface roughness of the humidifying rollers 111 and 121 and the surface roughness of the water supply rollers 112 and 122, creates the aforementioned conditions, thereby suppressing the occurrence of the pool W, and the experimental results will be explained below.

FIG. 6 is a drawing for explaining the surface waviness quantity.

The surface waviness quantity of a sheet mentioned here is the magnitude of the surface waviness at the end of the sheet that is expressed in a numerical value by the method shown in FIG. 6.

Firstly, an isosceles triangle formed from a vertex B1 of the undulation of the sheet referred to as surface waviness developed at the end of the sheet and bottoms A1 and A2 of the undulation is drawn.

Then, the sum of the lengths of the straight line connecting A1 and B1 and the straight line connecting B1 and A2, that is, the sum of the lengths of the oblique sides of the isosceles triangle is assumed as b1 and the length of the straight line connecting A1 and A2, that is, the base of the isosceles triangle is assumed as a1.

Similarly, b2 and a2 are obtained for the next undulation, and the measurement is repeated as far as the undulation at the last end, thus the values of a1 to an and b1 to bn are determined.

The surface waviness is defined as (b1+b2+ - - - +bn)−(a1+a2+ - - - +an) and the unit is mm.

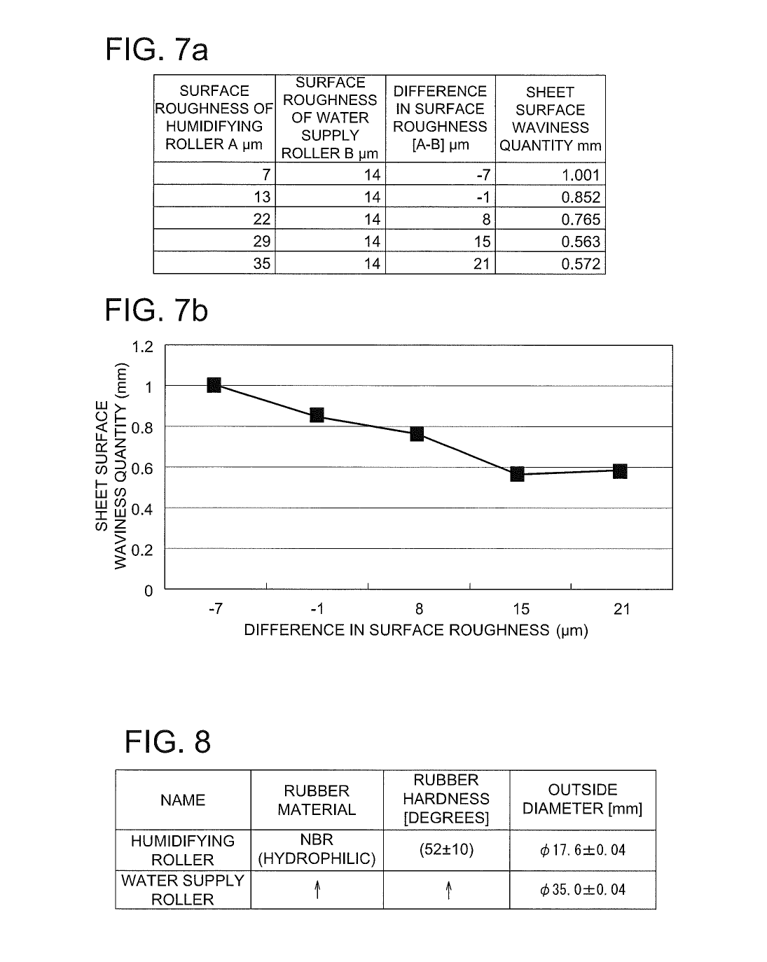

FIGS. 7a and 7b are graphs showing the relationship between the surface roughness of the humidifying rollers 111 and 121 and the water supply rollers 112 and 121 and the surface waviness quantity developed.

FIG. 8 is a list of the specifications of each roller used in the experimentation.

FIG. 7a is a table showing the surface waviness quantity of the sheets developed due to changes in the surface roughness of the humidifying rollers 111 and 121 using hydrophilic NBR (nitrile rubber) with a rubber hardness of 52±10.

Further, FIG. 7b is a graph showing the relationship between the difference in the surface roughness between the humidifying rollers 111 and 121 and the water supply rollers 112 and 122 and the surface waviness quantity developed.

As shown by the experimental results, when the surface roughness of the humidifying rollers 111 and 121 is higher than the surface roughness of the water supply rollers 112 and 122, the surface waviness quantity is reduced and the effect of the present invention is obtained.

Further, the surface roughness of each roller and the optimal value of the difference in the surface roughness are determined by experimentation at the time of design.

What is claimed is:

1. A sheet humidification device for performing a humidifying process to a sheet fed from an image forming apparatus fixing a toner image by heating the sheet carrying the toner image, comprising:
a humidifying roller for coating water on the sheet, and
a water supply roller arranged opposite to the humidifying roller for supplying water to the humidifying roller,
wherein a surface roughness of the humidifying roller is higher than the surface roughness of the water supply roller.

2. The sheet humidification device of claim 1,
wherein the humidifying roller and the water supply roller are composed of hydrophilic NBR rubber.

3. The sheet humidification device of claim 1,
comprising two sets of humidification mechanisms such having the humidifying roller, the water supply roller, and water storage pan for storing humidifying water and permitting the water supply roller to be partially immersed,
wherein the humidifying rollers of the two sets of humidification mechanisms are arranged opposite to each other and
the two sets of humidification mechanisms are arranged symmetrically on right and left, and water is coated on both sides of the sheet by conveying the sheet upward from below by the opposing humidifying rollers.

4. The sheet humidification device of claim 1,
further comprising a control roller for controlling the water retention quantity of the water supply roller by pressurizing the water supply roller.

5. An image forming system connected with an image forming apparatus and the sheet humidification device of claim 1.
